(19) United States
(12) Patent Application Publication
(10) Pub. No.: US 2014/0099949 A1
(43) Pub. Date: Apr. 10, 2014

(54) METHODS AND ARRANGEMENTS FOR HANDLING AN IDENTIFICATION OF AN AVAILABLE COVERAGE IN A CELLULAR NETWORK

(71) Applicant: Telefonaktiebolaget L M Ericsson (publ), Stockholm (SE)

(72) Inventors: István Gódor, Budapest (HU); Pål Frenger, Linköping (SE); László Hévizi, Piliscsaba (HU)

(73) Assignee: Telefonaktiebolaget L M Ericsson (publ), Stockholm (SE)

(21) Appl. No.: 14/124,056

(22) PCT Filed: Jun. 30, 2011
(86) PCT No.: PCT/SE2011/050885

§ 371 Date: Dec. 5, 2013

(51) Int. Cl. H04W 48/10

(52) U.S. Cl. CPC H04W 48/10
USPC 455/434

(57) ABSTRACT

A method in a base station for handling an identification of an available coverage in a cellular network is provided. The base station serves a first cell in the cellular network. The base station identifies a coverage of a second cell in the cellular network. When the second cell is in the active mode it overlaps a portion of the first cell. When the second cell is in the sleep mode, the base station transmits via the first cell a message to a user equipment located in the portion. The message comprises an indication of the coverage of the second cell, thereby enabling the user equipment to identify the coverage of the second cell as an available coverage for handling of an upcoming data transmission.

### TECHNICAL FIELD

Embodiments herein relate to a base station and a method in a base station. In particular, embodiments herein relate to handling an identification of an available coverage in a cellular network. Embodiments herein further relate to a user equipment and a method in a user equipment.

### BACKGROUND

In a typical cellular network, also referred to as a wireless communication system, User Equipments (UEs), communicate via a Radio Access Network (RAN) to one or more core networks (CNs).

A user equipment is a mobile terminal by which a subscriber can access services offered by an operator's core network. The user equipments may be for example communication devices such as mobile telephones, cellular telephones, laptops or tablet computers, sometimes referred to as surf plates, with wireless capability. The user equipments may be portable, pocket-storable, hand-held, computer-comprised, or vehicle-mounted mobile devices, enabled to communicate voice and/or data, via the radio access network, with another entity, such as another mobile station or a server.

User equipments are enabled to communicate wirelessly in the cellular network. The communication may be performed e.g. between two user equipments, between a user equipment and a regular telephone and/or between the user equipment and a server via the radio access network and possibly one or more core networks, comprised within the cellular network.

The cellular network covers a geographical area which is divided into cell areas. Each cell area is served by a base station, e.g. a Radio Base Station (RBS), which sometimes may be referred to as e.g. “eNB”, “eNodeB”, “NodeB”, or BTS (Base Transceiver Station), depending on the technology and terminology used. The base stations may be of different classes such as e.g. macro base station, home base station or pico base station, based on transmission power and thereby also on cell size.

A cell is the geographical area where radio coverage is provided by the base station at a base station site. One base station, situated on the base station site, may serve one or several cells. Further, each base station may support one or several communication technologies. The base stations communicate over the air interface operating on radio frequencies with the user equipments within range of the base stations.

In some radio access networks, several base stations may be connected, e.g. by landlines or microwave, to a radio network controller, e.g. a Radio Network Controller (RNC) in Universal Mobile Telecommunications System (UMTS), and/or to each other. The radio network controller, also sometimes termed a Base Station Controller (BSC) e.g. in GSM, may supervise and coordinate various activities of the plural base stations connected thereto. GSM is an abbreviation for Global System for Mobile Communications (originally: Groupe Special Mobile).

In 3rd Generation Partnership Project (3GPP) Long Term Evolution (LTE), base stations, which may be referred to as eNodeBs or eNBs, may be directly connected to one or more core networks.

UMTS is a third generation, 3G, mobile communication system, which evolved from the second generation, 2G, mobile communication system GSM, and is intended to provide improved mobile communication services based on Wideband Code Division Multiple Access (WCDMA) access technology. UMTS Terrestrial Radio Access Network (UTRAN) is essentially a radio access network using wideband code division multiple access for user equipments. The 3GPP has undertaken to evolve further the UTRAN and GSM based radio access network technologies.

In the context of this disclosure, a base station as described above will be referred to as a base station or a Radio Base Station (RBS). A user equipment as described above, will in this disclosure be referred to as a user equipment or a UE.

Cellular communication networks evolve towards higher data rates, together with improved capacity and coverage. In 3GPP, standardization body technologies like GSM, HSPA and LTE have been and are currently developed.

The current utilization of broadband mobile networks may however be low during quiet hours, such as for example night time. Daily traffic profiles in various networks indicate large peak-to-average ratios on network level, and the ratio is even larger for smaller urban or rural cells, where user occurrence and traffic can be very sparse. In the meantime, new RATs are deployed on top of the legacy access technologies, but the latter ones cannot be phased out for yet a long time due to legacy user equipments and services. Hence most operators have underutilized radio resources in their different RATs just to assure simultaneous capacity and coverage for old and new user equipments. Consequently, the operators face a continuously increasing electricity bill with each network upgrade.

Telecom equipment manufacturers, as well as various international organizations have been prioritizing the energy-efficiency aspect of both wireline and mobile networks and funds and research have been focused to this area in recent years.

In cellular networks, the most power-hungry components are the radio network nodes. The radio network nodes occur in a continuously increasing number in the cellular networks. However, radio network nodes such as base stations often operate at a very low utilization.

Therefore, modern broadband RATs will likely be able to adapt to the spatially and temporally varying traffic demand, by using sophisticated sleeping and standby operation modes. By exploiting these new energy-saving features, an advanced network management, which would handle and coordinate all RATs of a cellular network, can match the active radio resources to the instantaneous traffic demand without compromising service performance.

A problem is, however, that when a cell, or an entire RAT, in the cellular network is in the sleep or energy saving mode, the user equipments are unaware of their presence.

### SUMMARY

In view of the discussion above, it is an object for embodiments herein to provide an improved way of handling an identification of an available coverage in a cellular network.

According to a first aspect, the object is achieved by a method in a base station for handling an identification of an available coverage in a cellular network. The base station serves a first cell in the cellular network. The base station identifies a coverage of a second cell in the cellular network. The second cell is configured to alternate between an active mode and a sleep mode. When the second cell is in the active mode it overlaps a portion of the first cell. When the second cell is in the sleep mode, the base station transmits via the first cell a message to a user equipment located in the portion. The message comprises an indication of the coverage of the second cell, thereby enabling the user equipment to identify the coverage of the second cell as an available coverage for handling of an upcoming data transmission.

According to a second aspect, the object is achieved by a base station for handling an identification of an available coverage in a cellular network. The base station serves a first cell in the cellular network. The base station comprises an identification unit. The identification unit is configured to identify a coverage of a second cell in the cellular network. The second cell is configured to alternate between an active mode and a sleep mode. When in the active mode the second cell overlaps a portion of the first cell. The base station further comprises a transmitter. The transmitter is configured to transmit via the first cell, when the second cell is in the sleep mode, a message to a user equipment located in the portion. The message comprises an indication of the coverage of the second cell, thereby enabling the user equipment to identify the coverage of the second cell as an available coverage for handling of an upcoming data transmission.

According to a third aspect, the object is achieved by a method in a user equipment for handling an identification of an available coverage in a cellular network. The cellular network comprises a first cell served by a base station. The cellular network further comprises a second cell. The second cell is configured to alternate between an active mode and a sleep mode. When being in the active mode the second cell overlaps a portion of the first cell. When the user equipment is in the portion and when the second cell is in the sleep mode, the user equipment receives a message from the base station via the first cell. The message comprises an indication of a coverage of the second cell. The user equipment identifies the indicated coverage of the second cell as an available coverage for handling of an upcoming data transmission.

According to a fourth aspect, the object is achieved by a user equipment for handling an identification of an available coverage in a cellular network. The cellular network comprises a first cell served by a base station. The cellular network further comprises a second cell. The second cell is configured to alternate between an active mode and a sleep mode. When being in the active mode, the second cell overlaps a portion of the first cell. The user equipment comprises a receiver. The receiver is configured to receive a message from the base station via the first cell when the second cell is in the sleep mode. The message comprises an indication of a coverage of the second cell. The user equipment further comprises an identification unit. The identification unit is configured to identify the indicated coverage of the second cell as an available coverage for handling of an upcoming data transmission.

Thanks to the coverage of the second cell being identified by the base station and transmitted to the user equipment via the first cell when the second cell is in the sleep mode, the user equipment will still be able to identify the coverage of the second cell as an available coverage. This is advantageous since it enables an operator to save energy by having the second cell in the sleep mode until its services are needed, while the user equipment is still able to identify the coverage of the sleeping cells as being an available coverage for an upcoming data transmission to, or from, its current location.

This provides an improved way of handling an identification of an available coverage in the cellular network.

### BRIEF DESCRIPTION OF THE DRAWINGS

FIG. 1 is a schematic block diagram illustrating an embodiment of a cellular network.

FIG. 2 is a combined signalling scheme and flowchart illustrating embodiments in a cellular network.

FIG. 3 is a schematic block diagram illustrating an embodiment of a cellular network.

FIG. 4 is a schematic block diagram illustrating an embodiment of a cellular network.

FIG. 5 is a schematic illustration of an embodiment of an icon on a user equipment display.

FIG. 6 is a flowchart illustrating embodiments of method in a base station.

FIG. 7 is a block diagram illustrating embodiments of a base station.

FIG. 8 is a flowchart illustrating embodiments of method in a user equipment.

FIG. 9 is a block diagram illustrating embodiments of a user equipment.

### DETAILED DESCRIPTION

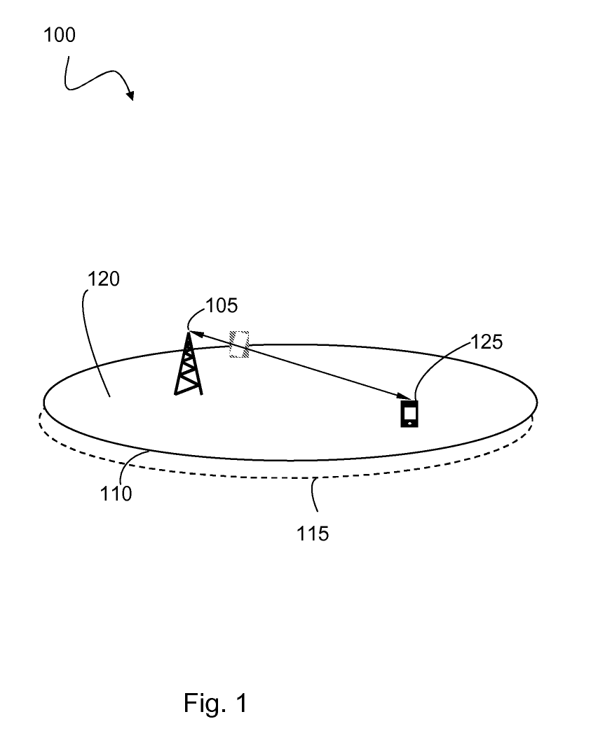

FIG. 1 depicts a cellular network 100. The cellular network 100 may be an LTE cellular network, a WCDMA cellular network, a GSM cellular network, any 3GPP cellular network, or a celluar network comprising and supporting a combination of different radio access technologies such as for example LTE, WCDMA and GSM, any other cellular network.

The cellular network 100 comprises a base station 105 serving a first cell 110. In this example, the first cell 110 is a GSM cell. The cellular network 100 further comprises a second cell 115 which in this example is an LTE cell and which in this example is co-located with the first cell 110 and also served by the base station 105.

The base station 105 may support more than one RAT. An example of such a base station 105 which supports more than one RAT, and which may serve cells belonging to different RATs, is the so called Radio Base Station 6000 (RBS6000). RBS6000 supports both GSM, LTE and WCDMA.

The base station 105 may in other embodiments be of another type, and may be referred to by different names, such as for example eNB, RBS, eNodeB, NodeB or BTS, depending on the technology and terminology used.

A portion 120 of the first cell 110 is overlapped by the second cell 115. In this example the first cell 110 and the second cell 115 provide coverage over the same area hence in this example the portion 120 corresponds to the entire first cell 110.

The cellular network 100 further comprises a user equipment 125.

The user equipment 125 may be for example a communication device such as a mobile telephone, a cellular telephone, a laptop, or a tablet computer, sometimes referred to as a surf plate, with wireless capability. The user equipment 125 may be a portable, pocket-storable, hand-held, computer-comprised, or vehicle-mounted mobile device, enabled to communicate voice and/or data with another entity, such as another mobile station or a server, via the first cell 110 or the second cell 115. The user equipment 125 in this example hence supports both GSM and LTE. It should however be noted that in this example, as well as in other embodiments herein, the user equipment 125, and/or the first cell 110 and/or the second cell 115 may belong to, or support, other RATs or combinations of RATs comprised in a group of for example GSM, WCDMA, or HSPA, and LTE. HSPA is an abbreviation for High Speed Packet Access.

It is also to be understood that FIG. 1 is merely a schematic illustration, and that the cellular network 100 may in reality comprise several further base stations, user equipments and other radio network nodes which are not shown in the FIG. 1.

As part of the development towards embodiments herein, a problem will first be identified and discussed below with reference to FIG. 1.

As previously mentioned, the base station 105 serves the first cell 110 which is of GSM type and the second cell 115 which is of LTE type, and the first cell 110 and the second cell 115 are co-located, i.e. provide coverage in the same area.

When the second cell 115 is in a so called active mode, cell information related to the second cell 115 is broadcast to user equipments inside it, and data connections can be established with the user equipment 125 via the second cell 115.

However, having both cells 110, 115 active at all times is power consuming and costly for the operator. Since several services, such as for example phone calls or other low rate data services such as checking for emails etc., do not necessarily require the advanced LTE capacity of the second cell 115, it may be preferred to have the second cell 115 in a sleep, or energy saving, mode when its services are not required. Also, other legacy user equipments (not shown) may not support LTE, and therefore would only require the services of the first cell 110 which is of a GSM type.

A problem is that, when the second cell 115 is in the sleep mode, it is in an energy saving state when no, or reduced, broadcasts are transmitted via the second cell 115 cell, and when no data connections are established via this cell to transmit data to or from the user equipment 125 located within it.

Hence, if an operator of the cellular network 100 puts the second cell 115 in a sleep mode, the user equipment 125, which supports LTE, is unaware of the coverage and potential data connection capacity of the second cell 115, which cell, being of an LTE type, is more advanced and a preferred option for some services requiring data transmission to or from the user equipment 125.

Therefore, there may be a reluctance from the operator's side to allow cells to enter the sleep mode, since they are not then detectable by the user equipments, and their coverage is not identifiable as an available coverage.

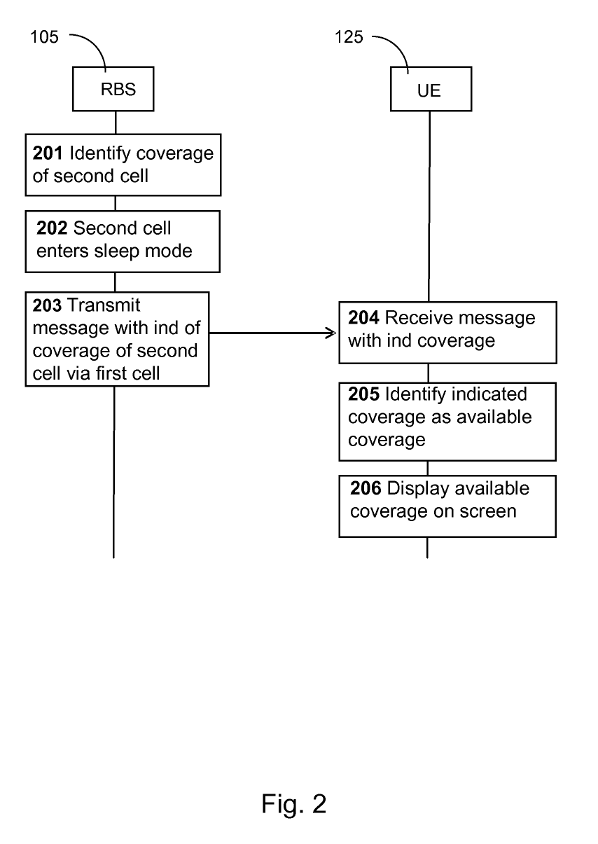

FIG. 2 illustrates a method in the base station 105 for handling an identification of an available coverage in the cellular network 100 depicted in FIG. 1, according to some embodiments herein. It is in the following assumed that the second cell 115 is configured to alternate between the sleep mode and the active mode.

In action 201, the base station 105 identifies a coverage of the second cell 115. In this example, the coverage of the second cell 115 is identified as being essentially the same as the coverage of the first cell 110, since these cells are co-located.

By “identifying a coverage” is understood determining or recognising a coverage of the second cell. This knowledge may be gained in different ways. In this example, where the second cell 115 is served by, or handled by, the base station 105 itself, the identifying may be performed by retrieving the coverage information from a memory comprised in the base station 105.

In action 202, the second cell 115 enters into the sleep mode, and data connections are no longer performed via the second cell 115.

The first cell 110, however, is still in the active mode, and the base station 105 still provides services via the first cell 110.

In action 203, the base station 105 transmits, via the active first cell 110, a message with an indication of the coverage of the sleeping second cell 115 to the user equipment 125.

In this example, the transmission is performed as a broadcast, since the information is relevant for the whole area covered by the first cell 110.

The indication may be that the coverage of the second cell 115, or second RAT, RAT2, i.e. LTE in this example, is similar to the coverage of the first cell 110 or first RAT, RAT1, i.e. GSM in this example This may work well with co-located serving base stations for the first cell 110 and second cell 115.

The GSM broadcast channels BCCH and PBCCH have placeholders for broadcasting non-GSM system information elements. These are the Packet System Information Type 6, 7 and the System Information Type 18, 20 on the Physical Broadcast Control Channel (PBCCH) and Broadcast Control Channel (BCCH), respectively. Hence, such information elements may be used for the transmitting of the message.

In action 204, the user equipment 125 receives the message with the indication of the coverage related to the sleeping second cell 115.

In action 205, the user equipment 125 identifies the indicated coverage of the second cell 115 as an available coverage for an upcoming data transmission.

In action 206 the user equipment 125 displays the identified available coverage on a screen of the user equipment 125, for example to inform a user of the user equipment 125 that there is identified available coverage of the sleeping second cell 115.

This may be done for example by displaying an icon such as a status icon on the screen. Such an icon may for example be a staple diagram of the type that is commonly used for indicating coverage, or field strength, on user equipments for indicating to a user a relative quality of an upcoming, or potential, radio communication service.

Optionally, the coverage of the first cell 110 may be displayed in combination with the available coverage of the sleeping second cell 115.

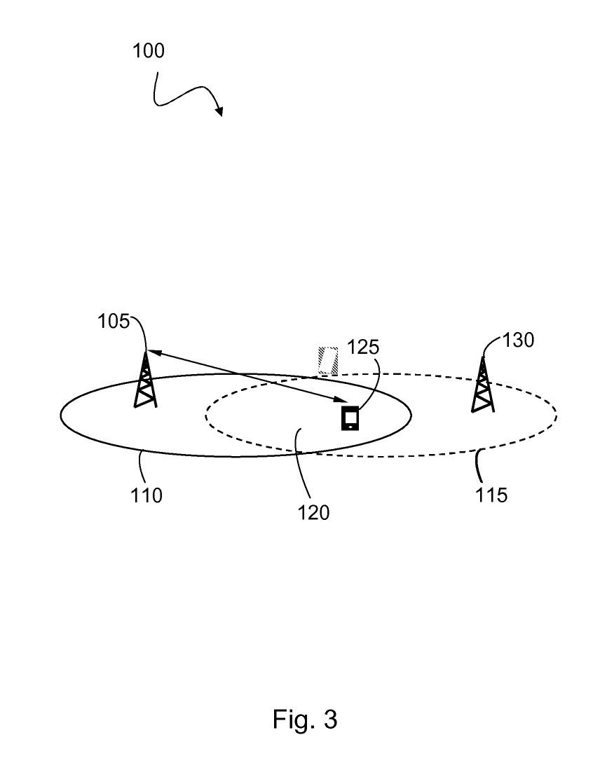

FIG. 3 schematically illustrates another embodiment of the cellular network 100 in which embodiments herein may be implemented.

In this embodiment, the second cell 115 is not co-located with the first cell 110, and the second cell 115 is served by a further base station 130 comprised in the cellular network 100.

By way of example only, the first cell 110 is assumed to be a GSM cell and the second cell is assumed to be an LTE cell in this example too, and the second cell 115 is here too assumed to enter the sleep mode.

In this scenario, the identifying corresponding to action 202 described above, may for example be performed by the further base station 130 sending an indication of the coverage of the second cell 115, possibly together with an indication that it is about to enter into the sleep mode. This information may in some embodiments also be provided by another network node which is not shown in the FIG. 3, such as a Mobility Management Entity (MME) or an Operation and Support System (OSS) node, or a Radio Network Controller (RNC) node, or a Base Station controller (BSC) node, or a another network node dedicated for this purpose.

In the scenario depicted in FIG. 3, the message may be transmitted in a different way from that described in action 203 above, since the first cell 110 and the second cell 115 are not co-located, and thus do not provide the same coverage.

The message may for example may be transmitted as a unicast transmission to the user equipment 125, since the portion 120, where the second cell 115 overlaps the first cell 110, does not correspond to the whole coverage zone of the first cell 110. In such scenarios, it may be advantageous to send the message only, or specifically, to user equipments within the portion 120.

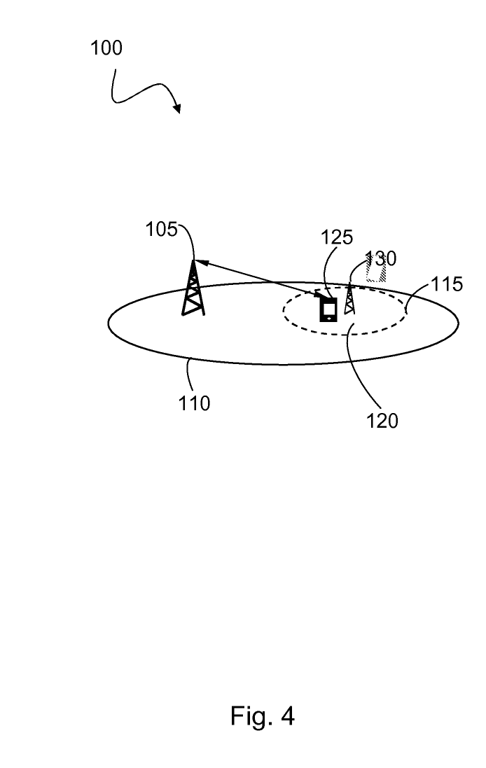

FIG. 4 illustrates yet another embodiment of the cellular network 100, wherein embodiments herein may be implemented. In this example too, the base station 105 serves the first cell 110 and the second cell 115 is served by a further base station 130.

In the embodiment depicted in FIG. 4, the second cell 115 is much smaller than the first cell 110, and covers an area inside the first cell 110.

An example of such an embodiment of the cellular network 100 is when the cellular network 100 is a so called heterogeneous Network (Het Net). HetNets comprise different size cells, including so called coverage cells such as the in FIG. 4 depicted first cell 110, and so called capacity cells, such as the in FIG. 4 depicted second cell 115. Capacity cells may be placed in hotspots where there is at least at times a need for increased capacity in the cellular network 100.

In such scenarios too, energy may be saved by using energy saving schemes where the capacity cell is put in the sleep, or standby, mode for example in hours with reduced traffic.

The further base station 130 depicted in FIG. 4 may sometimes be referred to as a low power node, or a pico base station, and the base station 105 depicted in FIG. 4 may sometimes be referred to as a macro base station. A macro base station output power may typically be 10-20 dBm higher than that of a low power node.

It is also possible that the base station 105 is distributed, so that an antenna is placed at the site of the further base station 130 in FIG. 4. The base station 105 then serves both the first cell 110 and the second cell 115 even if the cells are not co-located.

The first cell 110 and the second cell 115 may in this example belong to the same RAT or to different RATs. Even if they belong to the same RAT, for example LTE, it may be important to identify the coverage of the second cell 115 as an available coverage, since the user equipment 125, if located close to the centre of the second cell 115, would likely get a higher capacity data connection, i.e. better coverage, from the second cell 115 than from the first cell 110. This may for example be communicated, as described in action 206, by showing more staples on the displayed icon.

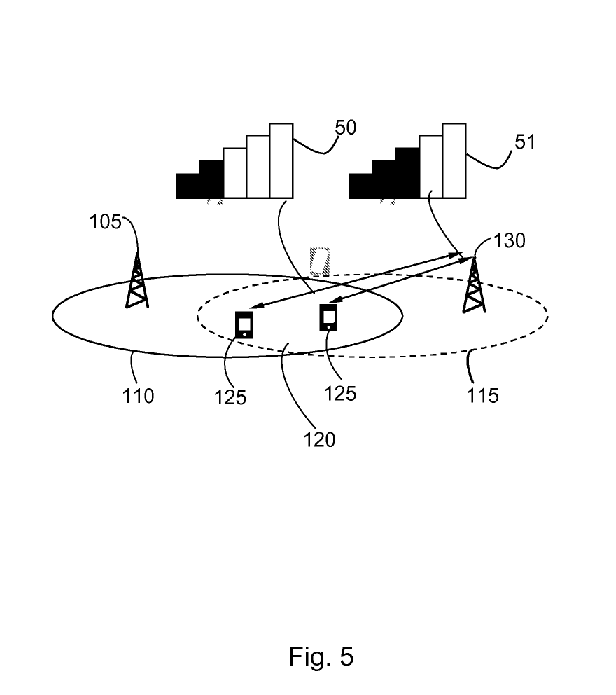

Examples of how the coverage of the sleeping second cell 115, and/or of the radio quality thereof, may be indicated to the user will be further exemplified with reference to FIG. 5 below.

FIG. 5 illustrates a scenario which is similar to that in FIG. 2. In FIG. 5, it is illustrated how the available coverage of the sleeping second cell 115 may be displayed in diagrams to the user of the user equipment 125, depending on how close the user equipment 125 is to the further base station 130 serving the second cell 115, or to the base station 105, if it is the base station 105 that serves the second cell 115.

The geographical distance between the user equipment 125 and the base station serving the sleeping second cell 115 may be used as a coarse indication of a potential signal quality, or data connection capability, related to the coverage of the sleeping second cell 115.

As can be seen in the FIG. 5, the available coverage from the second cell 115 gets better as the user equipment 125 approaches the further base station 130.

This is displayed on the screen by more filled bars in the displayed icon. FIG. 5 illustrates two examples of icons, with two and three filled bars respectively depending on the distance between the user equipment 125 and the base station 105, 130 that serves the second cell 115. When the user equipment 125 is further away from the base station serving the second cell 115, i.e. the further base station 130 in this example, an icon 50 with two filled bars is displayed, indicating a rather poor coverage, or data connection capability, or potential radio signal quality, by the second cell 115.

As the user equipment 125 approaches the serving base station of the second cell 115, i.e. the further base station 130 in this example, an icon 51 may be displayed. The icon 51 has three filled bars, indicating a better coverage by the sleeping second cell 115.

The location of the user equipment 125 relative to the base station 105, 130 that serves the second cell 115, may for example be estimated by a combination of measurements on base stations, e.g. Enhanced Reference Signal Received Power (E-RSRP) measurements, and/or Time Difference Of Arrival (TDOA) measurements, and/or measurements on external positioning satellite systems such as the Global Positioning System (GPS).

A more accurate indication of the potential data connection capability, or radio signal quality, of the second cell 115 for the user equipment 125 may be obtained by mapping the geographical location of the user equipment 125 to a certain potential radio signal quality, by utilising a data base of measurements collected when the second cell 115 was not in the sleep mode.

The user equipment 125 may change its status display, and replace for example a GSM or GPRS field strength icon with the corresponding icon for the available coverage related to the sleeping second cell 115, which may belong to another RAT such as WCDMA, or LTE. This icon, or these icons, may not be very different from the original GSM and GPRS icons, which are typically field strength indicator sticks and field strength indicator sticks in a frame, respectively.

In some embodiments, a different color, such as green, bars and a capital letter E may mark that coverage from a sleeping cell has been identified. This may then be referred to as a green connection state. Such an icon as for example the green connection state indication may send an impression towards the customers that the operator care about energy efficiency and the environment, and that the operator applies the advanced energy-saving features in its network. The icon may also serve as a notification to the user of the user equipment 125, to expect a short delay when initiating a high data rate service. Since activating the sleeping second cell 115 will take some time, an activation time in order of a second may might be a typical value, the icon may prepare the user of the user equipment 125 for this short initial delay. Thanks to the delay becoming predictable, it is less likely to annoy the user.

The message comprising the indication of the coverage of the second cell 115 may indicate that the coverage of the second cell 115 is at least as good as the coverage of the first cell 110, but could be better, or that the coverage of the second cell 115 is at least corresponding to a certain number of bars. This may be applicable when base stations for the first cell 110 and the second cell 115, that is for RAT1 and RAT2 in this example, are not co-located.

In some embodiments, the indication of the coverage of the second cell 115 may be expressed as a function, or a table, or a map, that the user equipment 125 may use to determine the coverage of the second cell 115 based on its physical location, e.g. Coverage_RAT2=f(UE_position), where the function f( ) is provided to the user equipment 125 via the first cell 110, i.e. via RAT1.

In some embodiments, the user equipment 125 may request to receive the estimated RAT2 coverage information from RAT1. The estimation of RAT2 coverage may be based on a user equipment 125 location or on uplink measurements, or on channel sounding transmissions from the user equipment 125 performed by the sleeping RAT2 base station 115 that is communicated to the user equipment 125 via the RAT1 base station 105. This however requires that the user equipment 125 when inactive communicates with the cellular network 100 for the purpose of updating the coverage display icon.

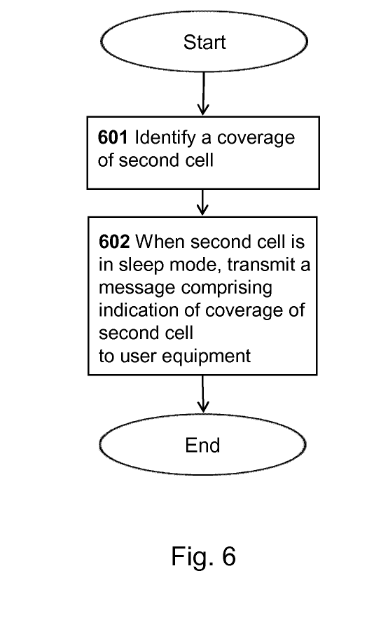

Embodiments herein, relating to a method in the base station 105 for handling an identification of an available coverage in the cellular network 100 will now be further elaborated and described with reference to the flowchart depicted in FIG. 6. These embodiments will be described in a more general way. As previously mentioned, the base station 105 is comprised in the cellular network 100. The base station 105 serves the first cell 110. The cellular network 100, the base station 105, and the user equipment 125 referred to below may be of any of the previously described types. The method comprises the following actions, which actions may be taken in any suitable order.

Action 601

In this action, the base station 105 identifies a coverage of the second cell 115 in the cellular network 100. The second cell 115 is configured to alternate between an active mode and a sleep mode. When being in the active mode, the second cell 115 overlaps a portion 120 of the first cell 110.

By sleep mode of a cell, is understood an energy saving mode, or standby mode, when the cell transmits fewer, or no, pilot signals with cell information. Also, no data connections are established via a cell, when the cell is in the sleep mode.

By a coverage of a cell, is in the context of this disclosure understood a geographical area within which user equipments may establish data connections and perform data transmissions via the cell when the cell is in the active mode.

By identifying a coverage, is understood obtaining knowledge about, or becoming aware of, or determining, a coverage. This may be performed for example by retrieving the coverage information from a memory, or performing measurements to obtain the coverage, or receiving the coverage information from a further base station, which may serve the cell in question, or a combination thereof.

Action 602

In this action, the base station 105 transmits via the first cell 110, when the second cell 115 is in the sleep mode, a message to the user equipment 125 located in the portion 120. The message comprises an indication of the coverage of the second cell 115, thereby enabling the user equipment 125 to identify the coverage of the second cell 115 as an available coverage for handling of an upcoming data transmission.

The transmitting may e.g. be performed by a broadcast transmission and/or by a unicast transmission to the user equipment 125.

In some embodiments, the message further comprises an estimate of a data connection capability of the second cell 115 for the upcoming data transmission.

The estimate of the data connection capability may then be based on a position estimate of the user equipment 125.

In some embodiments, the first cell 110 is associated with a first radio access technology, RAT1, which first radio access technology is one of GSM or WCDMA, and the second cell 115 is associated with a second radio access technology, RAT2, which second radio access technology is different from the first radio access technology, and which second radio access technology is one of WCDMA and LTE.

Since GSM is a legacy radio access technology compared to WCDMA and LTE, and WCDMA is a legacy radio access technology compared to LTE, this is a likely scenario, because operators may need to have the legacy cells in an active mode to ensure that legacy user equipments which do not support the upgraded radio access technologies can be reached and communicated with.

In some embodiments, the base station 105 further serves the second cell 115.

This may be the case for example if the base station 105 is a RBS 6000 or is of another base station type which supports several RATs, or if the base station 105 is a distributed base station in a HetNet as previously described above.

In some embodiments, the cellular network 100 is a heterogeneous network. In these embodiments the first cell 110 is a coverage cell and the second cell 115 is a capacity cell in the heterogonous network as previously described. A coverage cell may be referred to as a macro cell, and a capacity cell may be referred to as a pico cell, or low power node cell.

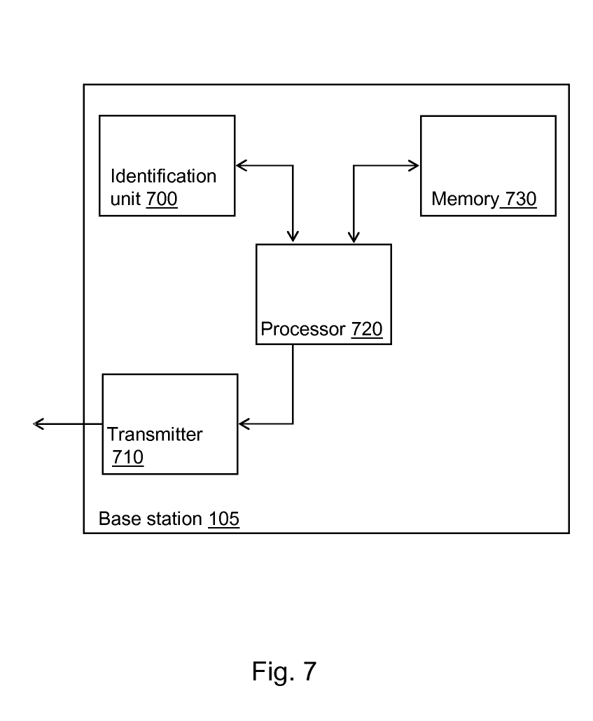

To perform the actions above for handling the identification of the available coverage in the cellular network 100, the base station 105 comprises an arrangement schematically depicted in FIG. 7. As mentioned above, the base station 105 is comprised in the cellular network 100. As also previously mentioned, the base station 105 serves the first cell 110.

The base station 105 comprises an identification unit 700. The identification unit 700 is configured to identify a coverage of the second cell 115 in the cellular network 100. In some embodiments, the identification unit 700 is further configured to identify the coverage of the second cell 115 by receiving it from a further base station 130, if the second cell 115 is served by the further base station 130. The second cell 115 is configured to alternate between the active mode and the sleep mode. When being in the active mode the second cell 115 overlaps a portion 120 of the first cell 110.

The base station 105 further comprises a transmitter 710. The transmitter 710 is configured to transmit via the first cell 110, when the second cell 115 is in the sleep mode, a message to the user equipment 125 located in the portion 120. The message comprises an indication of the coverage of the second cell 115, thereby enabling the user equipment 125 to identify the coverage of the second cell 115 as an available coverage for handling of an upcoming data transmission.

In some embodiments, the transmitter 710 is further configured to transmit the message by performing a broadcast transmission.

In some embodiments, the transmitter 710 is further configured to transmit the message by performing a unicast transmission to the user equipment 125.

According to some embodiments, the message further comprises an estimate of a data connection capability of the second cell 115 for the upcoming data transmission.

The estimate of the data connection capability may then be based on a position estimate of the user equipment 125.

In some embodiments, the first cell 110 belongs to a first radio access technology, RAT1, which first radio access technology is one of GSM or WCDMA, and the second cell 115 belongs to a second radio access technology, RAT2, which second radio access technology is different from the first radio access technology, and which second radio access technology is one of WCDMA and LTE.

The base station 105 may be further configured to serve the second cell 115.

The cellular network 100 may be a heterogeneous network. The first cell 110 may then be a coverage cell and the second cell 115 may then be a capacity cell in the heterogonous network.

The embodiments of the base station 105 for handling an identification of an available coverage in the cellular network 100, may be implemented through one or more processors, such as a processor 720 in the base station 105 depicted in FIG. 7, together with computer program code for performing the actions of embodiments herein.

The program code mentioned above may also be provided as a computer program product, for instance in the form of a data carrier carrying computer program code for performing the embodiments herein when being loaded into the base station 105.

One such carrier may be in the form of a CD ROM disc. It is however feasible with other data carriers such as a memory stick. The computer program code may furthermore be provided as pure program code on a server and downloaded to the base station 105 e.g. remotely.

The base station 105 may further comprise a memory 730 comprising one or more memory units. The memory 730 may be arranged to be used to store data such as for example the coverage of the second cell 115, and/or a function for calculating the coverage, and/or a data connection capability of the second cell 115, or a function for calculating the data connection capability of the second cell 115 and/or an estimate of a position of the user equipment 125 and/or a function for calculating the position estimate. It may further be arranged to store applications to perform the actions of the embodiments herein when being executed in the base station 105.

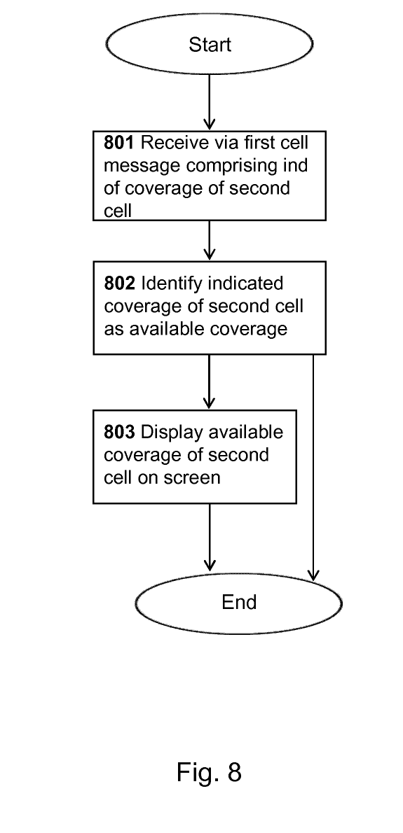

Embodiments herein, relating to a method in the user equipment 125 for handling an identification of an available coverage in the cellular network 100 will now be further elaborated and described with reference to the flowchart depicted in FIG. 8. These embodiments will also be described in a more general way.

As previously mentioned, the cellular network 100 comprises the first cell 110 served by the base station 105. The cellular network 100 further comprises the second cell 115. The second cell 115 is, as also previously described, configured to alternate between an active mode and a sleep mode. When the second cell 115 is in the active mode it overlaps a portion 120 of the first cell 110.

The method comprises the following actions, which actions may be taken in any suitable order.

Action 801

This action is performed when the user equipment 125 is located in the portion 120 and when the second cell 115 is in the sleep mode. In this action, the user equipment 125 receives via the first cell 110 a message from the base station 105. The message comprises an indication of a coverage of the second cell 115.

Action 802

In this action, the user equipment 125 identifies the indicated coverage of the second cell 115 as an available coverage for handling of an upcoming data transmission.

Action 803

This is an optional action according to which the user equipment 125 displays the identified available coverage of the second cell 115 on a screen of the user equipment.

The displaying may comprise displaying of an icon on the screen. The icon may be configured to indicate the identified available coverage, or an estimated coverage of the second cell 115, on the screen.

The displaying may further comprise displaying an estimate of a data connection capability, or an achievable radio quality, of the second cell 115.

This may be estimated based on the received indication of the coverage of the second cell 115, as well as on an estimate of the location of the user equipment 125.

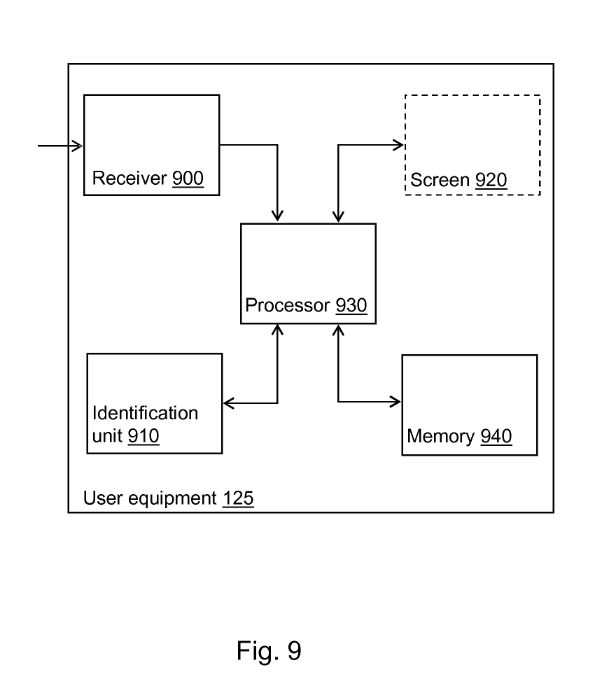

To perform the actions above for handling an identification of an available coverage in a cellular network 100, the user equipment 125 comprises an arrangement schematically depicted in FIG. 9.

The user equipment 125 may be of any of the previously described types.

As previously mentioned, the cellular network 100 comprises the first cell 110 served by the base station 105, and the second cell 115, which second cell 115 is configured to alternate between the active mode and the sleep mode. When the second cell 115 is in the active mode, it overlaps a portion 120 of the first cell 110.

The user equipment 125 comprises a receiver 900. The receiver 900 is configured to, when the user equipment 125 is located in the portion 120 and the second cell 115 is in the sleep mode, receive, via the first cell 110, a message from the base station 105. The message comprises an indication of a coverage of the second cell 115.

The user equipment 125 further comprises an identification unit 910. The identification unit 910 is configured to identify the indicated coverage of the second cell 115 as an available coverage for handling of an upcoming data transmission.

In some embodiments, the user equipment 125, further comprises a screen 920. The screen 920 is configured to display the identified available coverage of the second cell 115.

According to some embodiments, the display 920 is further configured to display the identified available coverage by displaying an icon.

According to some embodiments, the screen 920 is further configured to display an estimate of a data connection capability of the second cell 115.

The embodiments of the user equipment 125 for handling an identification of an available coverage in a cellular network 100 may be implemented through one or more processors, such as a processor 930 in the user equipment 125 depicted in FIG. 9, together with computer program code for performing the actions of embodiments herein.

The program code mentioned above may also be provided as a computer program product, for instance in the form of a data carrier carrying computer program code for performing the embodiments herein when being loaded into the user equipment 125.

One such carrier may be in the form of a CD ROM disc. It is however feasible with other data carriers such as a memory stick. The computer program code may furthermore be provided as pure program code on a server and downloaded to the user equipment 125 e.g. remotely.

The user equipment 125 may further comprise a memory 940 comprising one or more memory units. The memory 940 may be arranged to be used to store data such as for example the coverage of the second cell 115, and/or a function for calculating the coverage, and/or a data connection capability of the second cell 115, or a function for calculating the data connection capability of the second cell 115 and/or an estimate of a position of the user equipment and/or a function for calculating the position estimate. It may further be arranged to store applications to perform the actions of the embodiments herein when being executed in the user equipment 125.

Since several RATs are, or will likely be, simultaneously present in cellular networks, and some of the network resources are redundant in quiet hours, it is as previously mentioned expected that energy can be saved by switching off some of the unneeded resources. It is further expected that a clever network management will promptly provide the demanded service, even if resources have to be activated in a very short time. It is also foreseen that entire RATs, primarily 4G, optionally 3G, may be in standby mode in lack of traffic demand, and then they do not even transmit pilot signals for camping users, despite that their service essentially becomes immediately available as the demand appears. In lack of pilot signals, a user camping in another RAT, presumably on 2G which has to stay on due to legacy user equipments, may mistakenly assume that the service is not available at his/her location.

According to some embodiments herein, a network information element is introduced, which is communicated to those user equipments that camp or use voice service on a RAT, such as 2G, which has limited data connection capability, meanwhile, another RAT with broadband data connection capability, e.g. 3G or 4G, is in energy-saving standby mode in the same service area. This network information indicates to users that on-demand broadband data connection is available to them despite that the service is currently not directly visible to them. This network information could be used in areas, where operators have good coverage by multiple RATs and network management uses advanced energy-saving schemes in the hours with reduced traffic.

Upon receiving such network information, user equipments may for example display a “Green Connection” icon in their status displays indicating that a high capacity RAT is available in this area and thereby informing the user that when they initiate a broadband data connection then they will be handed over to the promptly activated high capacity broadband network and the Green Connection icon is replaced by the regular icon of the servicing RAT.

The icon could be titled as “Green Connection” and it may make a distinction between two cellular network connection stages, namely, the regular connection to the legacy, 2G, network or a connection to legacy network, but with broadband data connection option in the background.

The operators may have an accurate picture about the coverage of their legacy network, and some time, for example a few months, after the deployment and tuning of a new type of RAT, they may know the areas where overlapping coverage exists by the legacy and freshly deployed modern RAT. This is the target area for energy optimization, where energy may be saved by exploiting the novel energy-saving standby schemes of modern RATs, and where the cells of legacy RATs should broadcast the message comprising indications of the coverage of sleeping RATs or cells. The green connection icon may then signal to users with modern user equipments that the broadband service is still available to them even if they do not see other pilots than the pilots of legacy RATs.

Hence, embodiments herein may form a part of a set of techniques and equipment that a multi-RAT network management may use to govern the energy-saving standby states of nodes in modern broadband RATs. By the system information message that legacy network nodes would broadcast and the icons that user equipments would display, network operators would assure their customers that the broadband service they subscribed for is promptly provided even if it is not directly visible to them.

Moreover, many user equipments are configured to display to a user thereof, even when in a so called idle mode when no services are requested, an indication of the available coverage from the most advanced RAT at its current location. This may be an important feature to obtain user satisfaction, since, indeed, a user of a user equipment that supports advanced RATs, such as the user equipment 125, will likely expect coverage from the advanced RAT to be identified at as many locations as possible.

User equipments such as mobile telephony user devices typically display icons in the status line of their displays about the type of connection that the user equipments momentarily use. Such examples are the GSM field strength indication, GPRS, EDGE or 3G connections. Though users have the freedom to prioritize the type of network connection that they want to use, for example they may prefer GSM over 3G for the purpose of reducing the power consumption of their device, the typical and default network setting is that the user equipment automatically chooses the most advanced network connection that the device is capable of from the seen, that is identified, RATs.

Network management may overrule this practice, but for the sake of users' satisfaction, the guiding principle is that users should get what they pay for, and the users camp on the network that their device is best suited. Hence, users are used to, or assume, that their user equipment displays the coverage of the most advanced RAT that has been identified as providing coverage in their current location.

When using the word “comprise” or “comprising” it shall be interpreted as non-limiting, i.e. meaning “consist at least of”.

The term “configured to” used herein may also be referred to as “arranged to”.

The embodiments herein are not limited to the above described embodiments. Various alternatives, modifications and equivalents may be used. Therefore, the above embodiments should not be taken as limiting the scope of the invention, which is defined by the appending claims.

1. A method in a base station for handling an identification of an available coverage in a cellular network, which base station serves a first cell in the cellular network, the method comprising:
identifying a coverage of a second cell in the cellular network, which second cell is configured to alternate between an active mode and a sleep mode, and which second cell when being in the active mode overlaps a portion of the first cell, and
when the second cell is in the sleep mode, transmitting, via the first cell, a message to a user equipment located in the portion, which message comprises an indication of the coverage of the second cell, thereby enabling the user equipment to identify the coverage of the second cell as an available coverage for handling of an upcoming data transmission.

2. The method according to claim 1, wherein the first cell belongs to a first radio access technology, RAT1, which first radio access technology is one of GSM or WCDMA, and wherein the second cell belongs to a second radio access technology, RAT2, which second radio access technology is different from the first radio access technology, and which second radio access technology is one of WCDMA and LTE.

3. The method according to claim 1, wherein the base station further serves the second cell.

4. The method according to claim 1, wherein the cellular network is a heterogeneous network, and wherein the first cell is a coverage cell and the second cell is a capacity cell in the heterogonous network.

5. The method according to claim 1, wherein the transmitting is performed by a broadcast transmission.

6. The method according to claim 1, wherein the transmitting is performed by a unicast transmission to the user equipment.

7. The method according to claim 1, wherein the message further comprises an estimate of a data connection capability of the second cell for the upcoming data transmission.

8. The method according to claim 7, wherein the estimate of the data connection capability is based on a position estimate of the user equipment.

9. A base station for handling an identification of an available coverage in a cellular network, which base station serves a first cell in the cellular network, the base station comprising:
an identification unit, configured to identify a coverage of a second cell in the cellular network, which second cell is configured to alternate between an active mode and a sleep mode, and which second cell when being in the active mode overlaps a portion of the first cell, and
a transmitter, configured to transmit via the first cell, when the second cell is in the sleep mode, a message to a user equipment located in the portion, which message comprises an indication of the coverage of the second cell, thereby enabling the user equipment to identify the coverage of the second cell as an available coverage for handling of an upcoming data transmission.

10. The base station according to claim 9, wherein the first cell belongs to a first radio access technology, RAT1, which first radio access technology is one of GSM or WCDMA, and wherein the second cell belongs to a second radio access technology, RAT2, which second radio access technology is different from the first radio access technology, and which second radio access technology is one of WCDMA and LTE.

11. The base station according to claim 9, wherein the base station is further configured to serve the second cell.

12. The base station according to claim 9, wherein the cellular network is a heterogeneous network, and wherein the first cell is a coverage cell and the second cell is a capacity cell in the heterogonous network.

13. The base station according to claim 9, wherein the transmitter is further configured to transmit the message by performing a broadcast transmission.

14. The base station according to claim 9, wherein the transmitter is further configured to transmit the message by performing a unicast transmission to the user equipment.

15. The base station according to claim 9, wherein the message further comprises an estimate of a data connection capability of the second cell for the upcoming data transmission.

16. The base station according to claim 15, wherein the estimate of the data connection capability is based on a position estimate of the user equipment.

17. A method in a user equipment for handling an identification of an available coverage in a cellular network, which cellular network comprises a first cell served by a base station, and a second cell, which second cell is configured to alternate between an active mode and a sleep mode, and which second cell, when being in the active mode, overlaps a portion of the first cell, the method comprising:
when being located in the portion and when the second cell is in the sleep mode, receiving via the first cell a message from the base station, which message comprises an indication of a coverage of the second cell, and
identifying the indicated coverage of the second cell as an available coverage for handling of an upcoming data transmission.

18. The method according to claim 17, further comprising displaying the identified available coverage of the second cell on a screen of the user equipment.

19. The method according to claim 18, wherein the displaying comprises displaying of an icon on the screen.

20. The method according to claim 18, wherein the displaying further comprises displaying an estimate of a data connection capability of the second cell.

21. A user equipment for handling an identification of an available coverage in a cellular network, which cellular network comprises a first cell served by a base station, and a second cell, which second cell is configured to alternate between an active mode and a sleep mode, and which second cell, when being in the active mode, overlaps a portion of the first cell, the user equipment comprising:
a receiver, configured to, when the user equipment is located in the portion and when the second cell is in the sleep mode, receive via the first cell a message from the base station, which message comprises an indication of a coverage of the second cell, and
an identification unit, configured to identify the indicated coverage of the second cell as an available coverage for handling of an upcoming data transmission.

22. The user equipment according to claim 21, further comprising a screen configured to display the identified available coverage of the second cell.

23. The method according to claim 22, wherein the screen is further configured to display the identified available coverage by displaying an icon.

24. The method according to claim 22, wherein the screen is further configured to display an estimate of a data connection capability of the second cell.
